(19) United States
(12) Patent Application Publication
(10) Pub. No.: US 2025/0100181 A1
(43) Pub. Date: Mar. 27, 2025

(54) PROCESS FOR MANUFACTURING FIBER BOARDS WITH REDUCED VOC EMISSIONS

(71) Applicant: FIBERBOARD GMBH, Baruth (DE)

(72) Inventors: Bernd BUNGERT, Baruth (DE); Thomas HEINE, Baruth (DE); Martin SCHWENDY, Baruth (DE); Christian DÜMICHEN, Baruth (DE); André HENNIG, Baruth (DE)

(21) Appl. No.: 18/290,881

(22) PCT Filed: Jul. 21, 2022
(86) PCT No.: PCT/EP2022/070535

§ 371 Date: Jan. 22, 2024

(30) Foreign Application Priority Data
Jul. 23, 2021 (EP) 21187502.6

(51) Int. Cl. B27N 1/00; B27N 3/04; B27N 3/18

(52) U.S. Cl. CPC B27N 1/003; B27N 3/04; B27N 3/18

(57) ABSTRACT

The disclosure relates to a process for manufacturing fiber boards with reduced VOC emissions.

### CROSS-REFERENCE TO RELATED APPLICATIONS

This application is a U.S. National Phase application under 35 U.S.C. 371 of International Application No. PCT/EP2022/070535, filed on Jul. 21, 2022, which claims the benefit of European Patent Application No. 21187502.6, filed on Jul. 23, 2021. The entire disclosure of the above European patent application is incorporated herein by reference.

### FIELD

The disclosure relates to a process for manufacturing fiberboards with reduced VOC emissions, particularly for manufacturing HDF boards or MDF boards.

### BACKGROUND

This section provides background information related to the present disclosure which is not necessarily prior art.

A continuous process of manufacturing wood fibers using the dry-and-wet technique based on lignocellulosic material such as wood, straw, or bagasse includes, without being limited thereto, shredding of the raw material into free fibers or fiber aggregates, which, in subsequent steps, are coated with glue, dried, shaped, and pressed into a final product, the so-called board or fiberboard. Nowadays, the release of fibers from the raw material is preferably performed in a so-called thermomechanical process in a single step or in a thermal and mechanical process in at least two separate steps.

Before the first thermal treatment, the wood chips are usually washed to remove any contaminants such as dirt or stones. The thermal treating, i.e., the heating of the raw material, is, for example, performed in a first thermal treatment device at a preferred temperature of up to about 100 degrees Celsius, particularly under atmospheric pressure, and subsequently in a preferably pressurized second thermal treatment device at a temperature of, for example, approximately 150 to 190 degrees Celsius, particularly at a pressure of about 4 to 13 bar. The dwell time of the wood chips in the thermal treatment devices may be adjusted depending on the prevailing process conditions and may, for example, be between about 1 to 10 minutes. According to the related art, the thermal heating in the second thermal treatment device is preferably performed by means of vapor. The mechanical processing is then performed in a refiner, also referred to as a defibrator. The dwell time of the wood chip raw material in the refiner is of short duration. The energy that is converted into mechanical energy in connection with the mechanical processing turns into heat in the size reduction zone and appears as exhaust gas, in particular vapor, in the processing system, which is generated from the moisture in the raw material.

After defibrating in the refiner, the wood fibers are usually pneumatically transported to a fiber dryer, where the drying process is performed with a large amount of air and a controlled inlet air temperature of about 140 to 200 degrees Celsius, depending on the current fiber moisture. The fibers are mechanically separated from the drying air. The dried fibers are then further transported for shaping, pre-pressing, and final pressing of the board. The drying air is subjected to an exhaust gas wash. For this, wet washing, wet electro filters or biofilters, and a biological wastewater treatment are used.

According to the related art, the wood emissions released during the release of the fibers and the drying, especially in the second thermal treatment device, are, together with the fiber bulk material transported, from the first thermal treatment device via the refiner to the dryer, where the majority is separated from the fiber and finally moist drying air from the dryer is directed into the atmosphere after the exhaust gas wash. These wood emissions mainly contain volatile organic substances, so-called volatile organic compounds (VOCs).

Amongst the VOCs, there are substances whose solubility in water is so small in a moist exhaust gas wash that their separation degree is only a few percent or even near zero. This applies to terpenes in particular. It is therefore known that wet separation processes only achieve an emission reduction degree of 10 to 30%. The low solubility is due to the inherently low solubility of the substances in water, as well as the strong dilution in the drying air, which extremely reduces the partial pressure and thus the thermodynamic driving force. The terpenes originate from the resin of the wood used. They are volatile oils. They are also referred to as turpentine.

The remaining quantities that do not leave the dryer follow the fiber stream to the subsequent process units, where they are successively released into the surrounding atmosphere or appear as a residual product in the final product, the board. Thus, discharge of the emissions into the atmosphere can also take place from the final product.

From WO 99/10594 it is already known that the second thermal treatment device is provided with an upper outlet for degassing the organic emissions released there. Here, vapor is introduced in the lower part of the first thermal treatment device and the wood chips that intrude into the upper part of the first thermal treatment device are washed during the condensation of the vapor in the counterflowing vapor. This is achieved by the vapor moving up through the wood chip column to the colder wood chips in the upper part of the first thermal treatment device. The released emissions, exhaust air and vapor, which arise from the evaporation of the moisture in the wood chips, are separated and disposed of through the outlet in a corresponding device. This publication also reveals that the wood chips from the first thermal treatment device are transported to the refiner by means of a screw conveyor, which compresses and drains the wood chips during transport.

According to the disclosure document EP 1597427 A1, a method is known in which the exhaust gases arising during compression are disposed of in a screw conveyor via an outlet arranged in the compression zone. The plant according to this document is characterized in that an exhaust gas outlet for discharging evaporated moisture, which arises while compressing the wood chips and contains VOC-containing exhaust gases, is arranged in the compression zone.

EP 2 573 258 A1 describes a method and an apparatus for processing wood chips for the production of fibrous material containing wood. Regarding the washing of the wood chips, it is stated that this is done by heating up to about 90° C. using water heated up to 98° C.

U.S. Pat. No. 4,925,527 describes a method for recovering turpentine in a TMP (Thermal Mechanical Pulp) process, in which a gas stream is taken from a refiner and fed to a condenser.

EP 1 021 612 A1 describes a plant for producing and treating wood fibers, comprising a fiber-producing part, which is provided with a wood chip preheater and a beater, which serve to free the fibers from the wood chips, and at least one dryer stage, which serves to dry the fibers. Between the fiber-producing part and the dryer stage, a vapor separator part is provided, which includes a cyclone separator, whose inlet is connected to the blower line used for the fibers and the vapor obtained from the beater machine. The lower outlet of the cyclone separator is connected to a conveying/drying line for the fibers via a lock gate. The upper outlet of the cyclone separator is connected to devices that serve to separate volatile organic substances and recover heat from the vapor of the cyclone separator.

US 2012/227918 A1 describes a refiner steam separation system comprising a blowline for transporting a fiber material mixture from a refiner to an inlet of a vapor separator. The exhaust vapor is discharged from the separator through an exhaust vapor outlet. Cleaned fiber material is discharged from the separator through an outlet, which prevents a significant part of the exhaust vapor from reaching the outlet. A relay tube is connected to the outlet and a dryer duct and transports the cleaned fiber material between the two. A resin inlet is connected to the relay tube and supplies resin to it. The resin is mixed with the cleaned fiber material before the cleaned fiber material is dried in the dryer duct.

However, for the sake of environmentally friendly wood processing, there is a need to remove the VOCs even more efficiently from a process for producing fiberboards, especially for producing HDF boards or MDF boards, wherein a resource-saving process should also be enabled.

### SUMMARY

This section provides a general summary of the disclosure, and is not a comprehensive disclosure of its full scope or all of its features.

The solution to the problem is achieved according to the disclosure by a process for manufacturing fiberboards with reduced VOC emissions. Preferred configurations of the disclosure are given in the dependent claims and the following specification, each of which can represent an aspect of the disclosure individually or in combination.

A process for manufacturing fiberboards with reduced VOC emissions is described, wherein the process comprises at least the following process steps:
a) providing wood-containing wood chips;
b) thermally treating the wood chips in a thermal treatment device or in a plurality of thermal treatment devices;
c) shredding, in particular defibrating, the wood chips in a refiner;
d) gluing the shredded, in particular the defibrated, wood chips; and
e) pressing the shredded, in particular the defibrated and glued, wood chips to form the fiberboard,
wherein
f) vapor used or arising in the process is separated, in particular continuously, from the process at at least one vapor emission location in a controlled manner, wherein the vapor is separated in a predetermined quantity range such that a lower limit and an upper limit of the quantity range of the total separated vapor depend on at least one specification of the wood chips used in process step a).

Such a process allows for a particularly advantageous way to efficiently reduce the environmentally harmful VOC emissions in the production of fiberboards. Furthermore, a resource-saving process is possible.

The term VOCs (Volatile Organic Compounds) within the meaning of the present disclosure refers, in particular, to volatile compounds that are present in the wood used as a raw material for the process described herein. In particular, the VOCs described in this process are terpenes, which occur as wood oil in the wood. Examples include the following substances, which may occur in the percentages by weight given in brackets based on the VOCs contained: α-pinene (20 to 70%), β-pinene, (5 to 20%), limonene (1 to 5%), camphene (1 to 5%), phenol (0.2 to 2%). Further components can include myrcene, α-, β-phellandrene, 3-carene, cymene, terpinols, ocimene.

The term “controlled” within the meaning of the present disclosure means in terms of the separation of the vapor that the quantity and/or the material stream of the vapor to be separated is adjustable, preferably controllable. In this respect, emission locations of the vapor that are not adjustable and/or not controllable are not to be understood as a controlled separation of the vapor within the meaning of the disclosure.

The process described here is used to manufacture fiberboards. Fiberboards within the meaning of the present disclosure are understood in a generally known manner to be boards that have wood fibers within a matrix comprising a binder. For example, the fiberboards may be so-called medium-density fiberboards (MDF boards, with a density of, e.g., 700 to 800 kg/m³) or low-density fiberboards (LDF, with a density of, e.g., less than 650 kg/m³). Furthermore, so-called high-density fiberboards (HDF boards, with a density of, e.g., more than 800 kg/m³) may be manufactured using the described process. More preferably, MDF boards or HDF boards may be manufactured using the described process. Such fiberboards are particularly suitable in interior construction as under-roof boards or exterior cladding of walls. The boards are also widely used in the manufacture of furniture. Applying them as floor, ceiling, or wall coverings for the interior fitting of rooms is also suitable.

In the process described here, the provision of wood-containing wood chips according to process step a) is performed initially. In this step, basically any wood may be provided, which is coarsely shredded so that it may be provided as wood chips.

The wood used is not basically limited, for example, wood may be used that is selected from pine wood, spruce wood, larch wood, birch wood, beech wood, dead oak wood, alder wood, etc., however without being limited to this.

The raw wood may be processed into wood chips, for example, by roughly chopping the wood used as raw material and also debarking it and cleaning it of coarse impurities, i.e., for example, freeing it from sand components or stones. The size of the wood chips is not basically limited, as is known to persons skilled in the art of the production of fiberboards.

According to process step b) the process includes thermally treating the wood chips in a thermal treatment device or in a plurality of thermal treatment devices. In this process step, the wood chips may be treated with vapor or with hot water under pressure, for example, to already remove VOCs from the wood. Accordingly, the temperature in this process step may be at least partly in a range of above 100° C. In addition, the thermal treatment or treatments may serve to further clean the wood chips.

According to process step c), the wood chips are shredded in a refiner. In this process step, the wood that had previously been shredded coarsely is further shredded so that it assumes a form suitable for the boards to be produced. This may be adjusted, for example, by adjusting the grinding mechanism or the energy introduced into the wood chips and/or the duration of treatment of the wood chips, as is generally known to any persons skilled in the art. In particular, this process step may include defibrating the wood chips.

The shredded or defibrated wood chips obtained after process step c) are then glued according to process step d). Gluing is understood to mean, in particular, introducing the wood chips into a matrix comprising a binder serving as glue. The binder or glue may be, for example, a urea-formaldehyde resin, for example reinforced with melamine or phenol. In addition, the glue or binder is preferably curable, for example by applying heat, such that a stable structure is formed after curing, which can serve as the corresponding fiberboard.

Accordingly, the defibrated and glued wood chips may then be pressed according to process step e) to form a fiberboard, in particular by applying heat and/or electromagnetic radiation. Understandably, the specific parameters to be applied in this process step depend on the materials to be pressed, in particular on the glue or binder used.

In the process described here, it is further provided that according to process step f) vapor used or arising in the process is separated from the process at at least one vapor emission location in a controlled manner, wherein the vapor is separated in a predetermined quantity range such that a lower limit and an upper limit of the quantity range of the total separated vapor depend on at least one specification of the wood chips used in process step a). The separation of the vapor may preferably be performed continuously. Continuous separation of the vapor, for example, includes uninterrupted separation or continual periodic separation, thus including definable periodically recurring pauses.

In particular, by separating vapor used or arising in the process from the process at at least one vapor emission location in a controlled manner, wherein the vapor is separated in a predetermined quantity range such that a lower limit and an upper limit of the quantity range of the total separated vapor depend on at least one specification of the wood chips used in process step a), significant advantages can be achieved compared to the solutions from the related art.

The disclosure is based in particular on the fact that, by separating vapor from the process, VOCs can be separated from the production stream, as these accumulate in the vapor. Thus, a corresponding vapor separation results in a reduction of VOC emissions, such as exhaust gases or fumes from the manufactured product, i.e., the produced fiberboard.

Surprisingly, it has been found that it is not necessary to continuously separate large quantities of vapor from the process in order to achieve a significant reduction in VOC emissions. Rather, it has been found that even through the emission of comparatively small quantities of vapor almost the entire quantity of VOCs, especially terpenes, can be removed. This may significantly reduce the quantity of vapor removed and thus, for example, the quantity of vapor to be further processed. This may reduce the complexity and thus costs in the overall process.

In addition, in the manufacturing of fiberboards, it is often necessary to generate additional vapor in addition to the vapor already arising during the process in order to obtain a sufficient quantity of vapor for the corresponding processing steps. However, the generation of vapor is also associated with complexity and costs, which can be significantly reduced according to the disclosure.

In the process described herein, it is also exploited that, even though terpenes as the most important VOCs in this process have a boiling point of over 150° C., it has been found that even exhaust vapor streams or generally vapor streams with temperatures below 100° C. can contain considerable quantities of volatile organic substances, especially terpenes. Therefore, in the process described herein, it is advantageous to focus on the total separated quantity of vapor regardless of its origin or the local separation point.

The separation of vapor streams may basically be carried out using techniques from the related art, and it is advantageous that the vapor is treated to collect the VOCs and is not directly released into the environment along with the VOCs. For example, the vapor may be separated by means of overpressure or negative pressure. Separating the vapor in a predetermined quantity range such that a lower limit and an upper limit of the quantity range of the total separated vapor depend on at least one specification of the wood chips used in process step a) may be implemented in various ways, as described in greater detail below.

Following the process described herein, the produced fiberboards may be further processed, in particular, depending on their specific area of application. For example, the produced fiberboards may be sanded or sawed into smaller boards, or additional layers may be applied, for example in lamination processes. Furthermore, it is possible to introduce certain structures into the boards, which may serve as attachment to each other or to other substrates. In this way, the fiberboard may advantageously be directed to the desired application.

With regard to the at least one specification of the wood chips, it should be mentioned that only one specification may serve as the basis for determining the quantity of vapor to be separated, or preferably a plurality of specifications may serve as the basis for determining the quantity of vapor to be separated.

For example, one specification or a plurality of specifications may be selected from the following specifications.

In particular, a specification may be the quantity of wood chips used in the process. The quantity of both the wood chips and the vapor, e.g. in a batch process, may be the absolute quantity, or the quantity of both the wood chips and the vapor, e.g. in a continuous process, may be the quantity per unit of time. It is understandable that, regardless of the specific configuration and the components of the wood chips, the quantity of wood chips has a significant influence on the VOCs introduced into the process by the wood and thus equally on the VOCs to be discharged, such that the quantity of wood chips should preferably be taken into account when determining the quantity of vapor to be separated.

Alternatively or preferably in addition to the quantity of wood chips used, it may be preferred that a lower limit and an upper limit of the quantity range depend on the quantity of VOCs, especially terpenes, contained in the wood chips provided in process step a). Thus, it may be determined or estimated in particular what amount of VOCs and thus in particular what amount of terpenes occurring in wood per quantity of wood chips are included in the wood chips. In other words, the quantity of terpenes or VOCs present in the wood chips in percent by weight based on the quantity of wood chips may be considered.

This specification may be particularly advantageous, as it has been shown that different types of wood also have different quantities of terpenes. Accordingly, the quantity of VOCs present in a certain quantity of wood chips may depend on the specific type of wood used.

In particular, by selecting such specifications, the quantity of vapor to be separated can be reduced particularly reliably, as it is ensured that not too little vapor is separated due to variations in the VOCs occurring during the separation of the vapor and thus an undesirably high amount of VOCs emerge. In addition, the quantity of vapor to be separated and possibly to be produced can still be reliably reduced without the aforementioned risk.

It may also be advantageous for the quantity of VOCs, especially terpenes, contained in the wood chips used in process step a) to be determined by examining the wood chips used or to be estimated based on the type of wood chips used.

Determining the quantity of VOCs by examining the wood chips may enable a particularly exact determination of the VOCs contained in the wood chips, such that the determination of the quantity of vapor to be separated can also be performed very precisely. Here, the VOC quantity may be determined in a known manner by analyzing the components of the wood chips. This may be advantageous, for example, because the content of VOCs may simply be reduced by the emission of fumes during storage or due to variations of the VOCs contained in the same type of wood.

An estimation of the VOCs, especially terpenes, contained in the wood chips based on the type of wood chips used, in particular considering from which type of wood the wood chips are formed, may allow a particularly simple determination of the VOC quantity, wherein the complexity can be kept to a minimum. This configuration may be based in particular on the fact that different types of wood, such as birch or spruce, often have different amounts of VOCs such as terpenes but the quantity of VOCs contained, in particular the quantity of terpenes contained, is characteristic of the type of wood. Thus, knowing the type of wood used, the VOC quantity can be estimated in advance without having to perform analytics.

To ensure that possible inaccuracies in the VOC quantity of the respective wood are not critical, the amount of separated vapor may be determined including a definable safety factor, i.e., a definably larger amount of vapor than is necessary according to the utilized data on the quantity of terpenes may be separated. This also allows a particularly safe and reliable reduction in the amount of VOCs removed from the process.

It has been found that it is sufficient for the total separated quantity of vapor in process step f) to be within a quantity range from 0.5 to 100 times the mass, preferably from 0.5 to 50 times the mass, more preferably from 0.5 to 10 times the mass, based on the quantity of terpenes of the wood chips provided. This quantity is significantly below the quantity of vapor that is separated in solutions from the related art, for example in U.S. Pat. No. 4,925,527, but surprisingly is sufficient to remove essentially the total amount of VOCs from the process and thus significantly reduce the VOC emissions in the process for manufacturing fiberboards described herein. Thus, it has been shown that, for example, when the process described here or the quantity of vapor separated in the process is based on the quantity of VOCs such as terpenes introduced into the process by the wood chips, a surprisingly small quantity of vapor may be separated that is sufficient to solve the task according to the disclosure.

Alternatively or additionally, the dry mass of the provided wood chips may also be a good indicator for determining the quantity of vapor to be separated. As such, it may be advantageous for the total separated quantity of vapor in process step f) to be within a quantity range from 0.001 to 0.2 times the mass, preferably from 0.001 to 0.1 times the mass, more preferably from 0.001 to 0.02 times the mass, based on the dry mass of the wood chips provided.

Even with such a correlation, the quantity of vapor to be separated is significantly below the quantity that is separated in solutions from the related art, for example in U.S. Pat. No. 4,925,527, but is also surprisingly sufficient to remove almost the total amount of VOCs from the process and thus significantly reduce the VOC emissions in the process for manufacturing fiberboards described here. Thus, it has also been shown that, for example, when the process described here or the quantity of vapor separated in the process is based on the dry mass of the wood chips provided, a surprisingly small quantity of vapor may be separated that is sufficient to solve the task according to the disclosure.

Here, the dry mass of the wood or the wood chips refers in particular to absolutely dry (atro—absolut trocken) wood, as is customary in wood processing in general. The dry mass of wood used may in turn be determined analytically or estimated based on known data for the type of wood used. Furthermore, in continuous or batch processes, the mass may be easily determined as a quantity per unit of time or as an absolute quantity, as described above.

It has also been shown that it is advantageous for at least one vapor emission location to be positioned upstream of the refiner, i.e. in processing order before the refiner. It has been shown that a significant amount of VOCs are already removed from the wood before the refiner, and it is therefore advantageous to remove the VOCs from the process by vapor separation before the refiner. On the one hand, this may realize an effective VOC removal. Furthermore, it can be prevented that the VOCs are carried along in the process, which can make removal more difficult.

With regard to the positioning upstream of the refiner, it may be particularly advantageous for the vapor emission location positioned upstream of the refiner to include a thermal treatment device or to be positioned between the refiner and a thermal treatment device, such as a cooker. It has been shown that VOCs, especially terpenes, can be effectively removed from the process at these positions by vapor separation, enabling the process to be performed particularly effectively in this configuration. Accordingly, it may also be advantageous for the vapor emission location to be a vapor treatment device before a wood chip cooker or the wood chip cooker itself, or to be located between the vapor treatment device and the cooker. At these emission locations too, it has been shown that VOCs, and especially terpenes, can be effectively removed from the process.

Here, a vapor separation upstream of a position such as that of the refiner may be a position at the main material stream of the wood chips or a vapor recirculation, which, although it runs in the opposite direction to the main material stream, may still be described as upstream due its position adjacent to the corresponding position of the main material stream or due to the routing of the vapor recirculation. Thus, for example, a vapor recirculation from the refiner to a thermal treatment device is to be considered as upstream of the refiner.

As described above, it may be very effective to separate the vapor at one or more vapor emission locations upstream of the refiner. In particular, since the process described here is characterized by the fact that only a very reduced quantity of vapor is separated, it may be advantageous, in order to enable a particularly effective vapor separation and remove the VOCs as completely as possible from the process, for at least one vapor emission location to be positioned downstream of the refiner. This configuration thus allows, even if not all terpenes are removed upstream of the refiner, to drive these out of the process downstream of the refiner.

Especially in this configuration, a reduction of the VOC emissions may be reduced particularly effectively.

In terms of an effective reduction of the VOC emissions, it may be particularly advantageous for the vapor emission location positioned downstream of the refiner to be a vapor separator positioned downstream of the refiner. A vapor separator is understood to be a device intended to remove vapor from the process. In addition to effective VOC reduction, this configuration can thus also be implemented without the need for a complex apparatus.

It may also be preferred that at least one vapor emission location is generated from a liquid stream. In this configuration, vapor can thus emerge from a correspondingly hot liquid stream, which is then separated, or a cooler liquid stream from which no vapor emerges can be heated until vapor emerges in order to separate the thus generated vapor streams.

In this configuration, it can be taken into account that VOCs or terpenes, which have escaped from the wood, do not only accumulate in the vapor but are also found in liquid streams, at least in small quantities. By vapor emission from these liquid streams, such fractions of VOCs may then be effectively removed from the process, which can further render the reduction of the VOCs as a whole effective.

Examples of liquid streams in which VOCs could be found include a squeeze water stream directly from a compaction screw or a liquid stream emerging from a squeeze water stream from a compaction screw.

It may also be advantageous for the VOC-containing vapor removed according to process step g) to be collected and, if applicable, one or more components to be treated further. In this configuration, the process may thus not only serve to reduce the VOC emissions but also be performed much more economically due to the possibility of collecting separated vapor streams and possibly treating them further. This is due to the fact that the materials contained in the vapor stream or other properties of the vapor stream, such as its heat, may be used in the process or other processes, such that costs and resources can be saved.

For example, it may be advantageous that, as further treatment, a mixture of terpenes or turpentine oil is isolated. While such substances should indeed be reduced as emissions of the process for manufacturing fiberboards to prevent their release into the environment, these substances may be valuable products for other processes or applications. Thus, this configuration may be particularly advantageous in terms of the economy of the process described here and in terms of the value creation of the wood used. The same applies if, as further treatment, a hydrolate is isolated. Within the meaning of the disclosure, a hydrolate is generally understood to be the aqueous phase obtained after condensation of the vapor, in which respective water-soluble components may be contained, such as formaldehyde.

Furthermore, it may be advantageous that the separated vapor or one or more components are further treated by combustion or exposure to high temperatures, adsorption, absorption, membrane technology techniques, condensation, crystallization, or other suitable process engineering techniques.

The combustion or exposure to high temperatures allows, for example, a thermal afterburning and thereby possibly an energetic use of the VOCs contained in the separated vapor stream. The other mentioned techniques may each refer to isolating or separating individual substances.

It may also be advantageous for the heat of a material stream occurring in the process, for example a separated vapor stream, to be energetically reused in the process. In this configuration, the energy inherent in the material stream in the form of heat may thus be reused, in particular to heat other material streams. This step too may improve economic aspects of the process according to the disclosure and thus save costs and resources.

Further areas of applicability will become apparent from the description provided herein. The description and specific examples in this summary are intended for purposes of illustration only and are not intended to limit the scope of the present disclosure.

### DRAWINGS

The drawing described herein is for illustrative purposes only of selected embodiments and not all possible implementations, and are not intended to limit the scope of the present disclosure.

The disclosure will be explained by way of example in more detail below with reference to the accompanying drawing using preferred exemplary embodiments, wherein the features shown below may represent an aspect of the disclosure both individually and in combination.

FIG. 1 shows a schematic representation of a process according to the present disclosure.

### DETAILED DESCRIPTION

Example embodiments will now be described more fully with reference to the accompanying drawing.

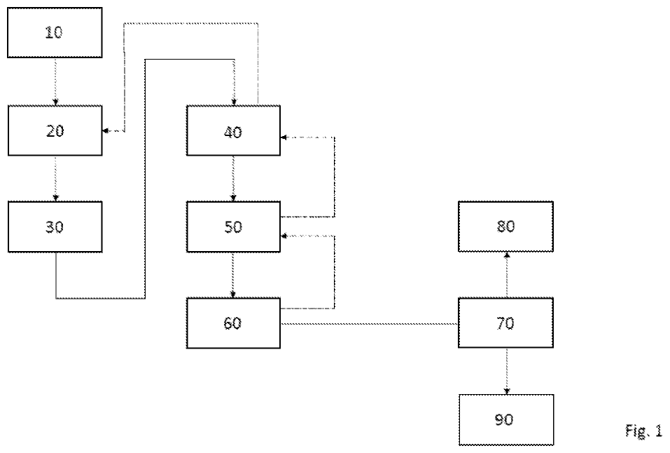

In FIG. 1, a process according to the present disclosure is shown schematically. Here, full arrows are intended to indicate the main material stream, and dashed arrows are intended to show a vapor recirculation.

In step 10, wood chips are provided. These are formed from a basically selectable wood and are provided by a coarse reduction in the size of the wood and in particular by a coarse wash.

Subsequently, the wood chips are treated in a plurality of thermal treatment devices. This is realized in a first thermal treatment step 20, in a second thermal treatment step 40, and in a third thermal treatment step 50.

Within the meaning of the disclosure, it is generally provided that VOC-containing exhaust gases have a high temperature. This means, in particular, a temperature greater than the boiling point of water, i.e. 100° C., such that this temperature may at least partially also be present during the thermal treatment.

The first thermal treatment step 20 is performed in a so-called pre-pre-vapor container at a preferred temperature of up to about 100° C., particularly under atmospheric pressure. This is a first thermal treatment of the wood chips and is performed using vapor, preferably water vapor. Here, a part of the VOCs may be transferred from the wood chips to the vapor. This VOC-containing vapor may be removed from the first thermal treatment device at a vapor emission location, preferably from the device's upper portion and, for example, via a pipeline arranged on the roof.

Subsequently, before the second thermal treatment step 40, the wood chips are washed or cleaned in a cleaning step 30. The cleaning of the wood chips in a washing device is performed particularly at a temperature above room temperature and less than or equal to the boiling point of water, particularly between 80° C. and 100° C. An elevated temperature allows a better separation of wood chips and foreign substances. Thus, foreign substances that are not wood chips are filtered out of the processing system and removed. The cleaning of the wood chips is preferably performed with a water-containing, in particular a water-based, medium.

It is an advantageous option for the washing device to receive the aforementioned VOC-containing condensate from the first thermal treatment device. This VOC-containing condensate may be removed from the processing system together with VOCs released during washing.

The second thermal treatment step 40 of the wood chips is performed in the second thermal treatment device, also called a pre-vapor container, which is configured to receive and discharge VOC-containing exhaust gases, in particular back into the first thermal treatment device. The second thermal treatment is performed, for example, without pressure at a temperature above room temperature, particularly at a temperature less than or equal to the boiling point of water, i.e. less than or equal to 100° C. An elevated temperature allows for better release of VOCs from the wood chips. The VOC-containing exhaust gases are, in particular, discharged from the second thermal treatment device and/or directed into the first thermal treatment device. Furthermore, VOC-containing exhaust gases from a device subsequently used to perform the process may be fed into the second thermal treatment device in order to further heat the wood chips or to release VOCs.

As an example and independent of other features, it is possible that the second thermal treatment of the wood chips in the second thermal treatment device is performed using vapor, preferably water vapor. Here, a part of the VOCs may be transferred from the wood chips to the vapor. This VOC-containing vapor may be discharged from the second thermal treatment device, preferably from its upper portion and, for example, via a pipeline arranged on the roof. Alternatively or in addition to the discharge of the VOC-containing vapor, some or all of the vapor may condense and release VOCs from the wood chips as a condensate. This VOC-containing condensate may, for example, be directed into a compaction screw, a cooker, and/or a water treatment plant.

The third thermal treatment step 50 may, in particular, be performed in a so-called cooker. The cooking of the wood chips in the cooker, which may be configured to receive and discharge VOC-containing exhaust gases, is performed, for example, at a temperature above room temperature, particularly between 3 bar and 15 bar, both inclusive, preferably between 5 bar and 13 bar, both inclusive, preferably at 9 bar, at a temperature greater than the boiling point of water, i.e. 100° C., such as at 90 to 175° C. An elevated temperature allows for better release of VOCs from the wood chips. The cleaning of the wood chips is preferably performed with a water-containing, in particular a water-based, medium. The first and second thermal treatments have heated and softened the wood chips such that VOCs contained in the wood chips are efficiently released from the cooker. A droplet separator is preferably connected downstream of the cooker.

It is an advantageous option for a compaction screw upstream of the cooker and/or the cooker itself to receive the aforementioned VOC-containing condensate from the second thermal treatment device. This VOC-containing condensate may be discharged from the processing system via the compaction screw and/or via the cooker together with VOC optionally released during the cooking.

Subsequently, the wood chips are shredded in a shredding or defibrating step 60 in the refiner. The configuration and operation of the refiner may be adaptable to the desired area of application of the board. In principle, a grinding energy of 50 to 200 kWh per ton of wood chips may be introduced via grinding tools, which are part of the refiner and defibrate the wood chips. A lower grinding energy such as around 50 kWh per ton of wood chips is suitable for floor coverings, 150 kWh per ton of wood chips for high-quality furniture.

Starting from the refiner, the defibrated wood chips or the wood fibers obtained in this way are guided through a so-called blowline, and a drying step 70 for drying the wood fibers coming from the refiner is performed in a dryer. This may again be performed at elevated temperatures, wherein the resulting moist atmosphere may be removed from the wood fibers by a separation step 80. The exhaust air may, for example, be washed, such that the last components, especially VOC-containing components, can be washed out and possibly reused or collected.

The dried defibrated wood chips or the wood fibers obtained in this way are processed into fiberboards in a processing step 90. For this purpose, the defibrated wood chips may be glued, and the glued defibrated wood chips may be pressed into a board. Subsequently, the board may receive its final processing for the specific application.

In the process described herein, vapor is generated or additional vapor is supplied. To advantageously remove the VOCs emerging from the raw wood during the process, it is provided that vapor used or arising in the process is continuously separated from the process at at least one vapor emission location, wherein the vapor is separated in a predetermined quantity range such that a lower limit and an upper limit of the quantity range of the total separated vapor depend on at least one specification of the wood chips used in process step a).

Thus, the separation of the vapor for removing VOCs depends on the VOCs introduced into the process by the wood chips or their wood. This may be performed, for example, taking into account the quantity and/or type of wood introduced or specifically the quantity of VOCs introduced. In particular, the total separated quantity of vapor may be within a quantity range from 0.5 to 100 times the mass, preferably from 0.5 to 50 times the mass, more preferably from 0.5 to 10 times the mass, based on the quantity of terpenes of the wood chips provided. Alternatively or additionally, the total separated quantity of vapor may be within a quantity range from 0.001 to 0.2 times the mass, preferably from 0.001 to 0.1 times the mass, more preferably from 0.001 to 0.02 times the mass, based on the dry mass of the wood chips provided.

Various vapor emission locations may be used to separate the vapor and thus to remove the VOCs. A vapor emission location is, in particular, understood to be a location at which vapor can be separated from the process.

For example, the following vapor emission locations are suitable for separating vapor: the pre-pre-vapor container or a first thermal treatment device, the pre-vapor container or a second thermal treatment device, the cooker or the third thermal treatment device, or the refiner. Also suitable are transport units such as a screw or conveying apparatuses, such as after the first thermal treatment device, between the second and third thermal treatment devices, or a transport unit, such as a screw between the third thermal treatment device and the refiner. Also suitable are a dewatering unit, such as a dewatering screw, or a vapor recirculation between individual processing units.

However, it has been found that the following gas emission locations are particularly suitable.

For example, at least one gas emission location may be positioned upstream of the refiner. Positions in this regard include, for example, a thermal treatment device or a position in a vapor recirculation between the refiner and a thermal treatment device, a vapor treatment device before a wood chip cooker or the wood chip cooker itself, or a vapor recirculation between the vapor treatment device and the cooker.

Alternatively or additionally, it may be advantageous for at least one vapor emission location to be positioned downstream of the refiner. In this regard, it is advantageous for the vapor emission location positioned downstream of the refiner to be a vapor separator positioned downstream of the refiner.

Furthermore, it may be particularly preferred for at least one vapor emission location to be generated from a liquid stream. Examples include a squeeze water stream directly from a compaction screw or a liquid stream emerging from a squeeze water stream from a compaction screw.

The process described herein enables a cost and resource-saving method for reducing the VOC emissions in the production of fiberboards, especially HDF or MDF boards.

The foregoing description of the embodiment has been provided for purposes of illustration and description. It is not intended to be exhaustive or to limit the disclosure. Individual elements or features of a particular embodiment are generally not limited to that particular embodiment, but, where applicable, are inter-changeable and can be used in a selected embodiment, even if not specifically shown or described. The same may also be varied in many ways. Such variations are to be regarded as a departure from the disclosure, and all such modifications are intended to be included within the scope of the disclosure.

1. A process for manufacturing fiberboards with reduced VOC emissions, wherein the process includes at least the following process steps:
a) providing wood-containing wood chips;
b) thermally treating the wood chips in a thermal treatment device or in a plurality of thermal treatment devices;
c) shredding the wood chips in a refiner;
d) gluing the wood chips; and
e) pressing the glued wood chips to form the fiberboard,
wherein
f) vapor used or arising in the process is separated continuously from the process at at least one vapor emission location in a controlled manner, wherein the vapor is separated in a predetermined quantity range such that a lower limit and an upper limit of the quantity range of the total separated vapor depend on at least one specification of the wood chips used in process step a).

2. The process according to claim 1, wherein a lower limit and an upper limit of the quantity range of the separated vapor depend on the quantity of wood chips provided in process step a).

3. The process according to claim 1, wherein, a lower limit and an upper limit of the quantity range of the separated vapor depend on the quantity of VOCs, especially terpenes, contained in the wood chips provided in process step a).

4. The process according to claim 3, wherein the quantity of VOCs, especially terpenes, contained in the wood chips used in process step a) is determined by examining the wood chips used or is estimated based on the type of wood chips used.

5. The process according to claim 1, wherein the total separated quantity of vapor in process step f) is within a quantity range from 0.5 to 100 times the mass, preferably from 0.5 to 50 times the mass, more preferably from 0.5 to 10 times the mass, based on the VOC quantity of the wood chips provided.

6. The process according to claim 1, wherein the total separated quantity of vapor in process step f) is within a quantity range from 0.001 to 0.2 times the mass, preferably from 0.001 to 0.1 times the mass, more preferably from 0.001 to 0.02 times the mass, based on the dry mass of the wood chips provided.

7. The process according to claim 1, wherein at least one vapor emission location is positioned upstream of the refiner.

8. The process according to claim 7, wherein the vapor emission location positioned upstream of the refiner includes a thermal treatment device or is located between the refiner and a thermal treatment device.

9. The process according to claim 7, wherein the vapor emission location positioned upstream of the refiner is a vapor treatment device before a wood chip cooker or the wood chip cooker itself, or is located between the vapor treatment device and the cooker.

10. The process according to claim 1, wherein at least one vapor emission location is positioned downstream of the refiner.

11. The process according to claim 10, wherein the vapor emission location positioned downstream of the refiner is a vapor separator positioned downstream of the refiner.

12. The process according to claim 1, wherein at least one vapor emission location is generated from a liquid stream.

13. The process according to claim 12, wherein the liquid stream is a squeeze water stream directly from a compaction screw, or a liquid stream emerging from a squeeze water stream from a compaction screw.

14. The process according to claim 1, wherein the VOC-containing vapor removed according to process step f) is collected and, if applicable, one or more components are further treated.

15. The process according to claim 14, wherein, as further treatment, a mixture of terpenes or turpentine oil is isolated.

16. The process according to claim 14, wherein, as further treatment, a hydrolate is isolated.

17. The process according to claim 14, wherein the separated vapor or one or more components are further treated by combustion or exposure to high temperatures, adsorption, absorption, membrane technology techniques, condensation, crystallization, or other suitable process engineering techniques.

18. The process according to claim 1, wherein the heat of a material stream occurring in the process is energetically reused in the process.

19. The process according to claim 1, wherein the heat of a separated vapor stream is energetically reused in the process.

20. The process according to claim 1, wherein the process is a thermomechanical process in which MDF boards or HDF boards are manufactured.
